(19) United States
(12) Patent Application Publication
(10) Pub. No.: US 2026/0307953 A1
(43) Pub. Date: Oct. 8, 2026

(54) Method and Construction Machine

(71) Applicant: Putzmeister Engineering GmbH, Aichtal (DE)

(72) Inventor: Florian SCHUMACHER, Wolfschlugen (DE)

(21) Appl. No.: 19/478,881

(22) PCT Filed: Apr. 24, 2024
(86) PCT No.: PCT/EP2024/061211

§ 371 Date: Oct. 27, 2025

(30) Foreign Application Priority Data
Apr. 28, 2023 (DE) 10 2023 111 034.9

(51) Int. Cl. B66C 23/90; E04G 21/04

(52) U.S. Cl. CPC B66C 23/905; E04G 21/0445

(57) ABSTRACT

A method for monitoring a load, which load acts on a discharge arm of a construction machine for conveying construction material and/or thick material, includes the steps: a) detecting a current angle value of a joint angle of a joint device of an arm unit relative to a joint axis; b) detecting a current pressure value of a hydraulic pressure of the arm unit to which a hydraulic device of the arm unit is subjected and/or a current force value as a function of the pressure value; c) forming a current value pair of the arm unit, in which value pair the current angle value resulting from step a) and the current pressure value or force value resulting from step b) are related to one another in order to monitor the load acting on the discharge arm on the basis of the current value pair.

### FIELD OF APPLICATION

The invention relates to a method for monitoring a load, which load acts on a discharge arm of a construction machine for conveying construction material and/or thick material. The invention further relates to such a construction machine for conveying construction material and/or thick material.

### OBJECT AND SOLUTION

It is an object of the present invention to provide a method for monitoring a load, which load acts on a discharge arm of a construction machine for conveying construction material and/or thick material, and such a construction machine for conveying construction material and/or thick material, which have improved properties. In particular, the monitoring of a load which applies a load to the discharge arm is intended to be made possible on the basis of a sensor system which the construction machine already has, in particular, for controlling its discharge arm.

This object is achieved by the subjects of the independent claims. Preferred embodiments form the subject of the dependent claims.

A method according to the invention serves for monitoring a load, wherein the load acts on a discharge arm of a construction machine for conveying construction material and/or thick material. The load can be dependent on a dead weight and/or external weight statically applying a load to the discharge arm. The load can be dependent on a collision of the discharge arm with an object in its environment. The load can be dependent on an inertial force when adjusting the discharge arm and/or a pulsation of a conveyed flow of construction material and/or thick material which is guided, in particular, along the discharge arm. The discharge arm can be a distribution boom of the construction machine for distributing construction material and/or thick material. The discharge arm has at least one arm unit. The arm unit has an arm member and a joint device which pivotably movably mounts the arm member relative to a machine base of the construction machine or relative to a further arm member of the construction machine about a joint axis of the arm unit. The arm member can be synonymously denoted as an arm segment. The arm unit can be synonymously denoted as an arm assembly. The arm unit also has a hydraulic device for pivotably adjusting the arm member relative to the machine base or to the further arm member about the joint axis. The hydraulic device can contain at least one, in particular dual-acting, hydraulic cylinder.

The method according to the invention has the steps explained below. According to a step a) of the method, a current angle value is detected of a joint angle of the joint device relative to the joint axis. A vertex of the joint angle can be located on the joint axis. The angle value can be related to at least one variable on which the joint angle depends. The angle value can directly specify the joint angle or, for example, be an adjustable longitudinal dimension of the hydraulic device. According to a further step b) of the method, a current pressure value is detected of a hydraulic pressure of the arm unit to which the hydraulic device of the arm unit is subjected. Alternatively or additionally, according to step b) a current force value can be detected as a function of the pressure value. According to a further step c) of the method, a current value pair of the arm unit is formed. The current angle value resulting from step a) and the current pressure value or force value resulting from step b) are related to one another in the value pair. The load acting on the discharge arm can be monitored on the basis of the current value pair. The method can be implemented by computer, in particular step c).

Expediently, the angle value can be detected by means of an angle detection device of the construction machine. Expediently, the pressure value can be detected by means of a pressure detection device of the construction machine. Expediently, the force value can be detected by means of a force detection device of the construction machine. Such detection devices can be designed for controlling the discharge arm so that, relative to the sensor system which is already present for the controlling, no additional detection devices are required for the method. In particular, it is possible to use a sensor system which is already present in a conventional construction machine for the detection devices for carrying out the method.

The term “configured” can be used synonymously for the term “designed”.

The term “contains” or “has” can be used synonymously for the term “comprises”.

In the present context “control” can mean “govern” and/or “regulate”.

The terms “pivotably movable”, “pivotable”, “rotationally movable” and “rotatably movable” and “rotatable” can be understood synonymously.

The terms “pivotably adjust” and “rotatably adjust” can be understood synonymously.

The terms “present” and “current” can be understood synonymously.

“Current values” can be “actual values” in the present context.

The steps of the method can be performed repeatedly, in particular so as to be updated and/or continuously. The steps a) and b) of the method can be carried out in each case by means of a corresponding detection device of the construction machine.

The construction material is preferably a thick material. The thick material can be a paste-like mixture of different materials. The thick material can be mortar, cement, screed or concrete, in each case in a mixable and/or conveyable state. In the mixable and/or conveyable state, the thick material has not yet cured or set.

In one embodiment of the invention, the step c) comprises a calculation of a joint torque of the arm unit acting on the arm member relative to the joint axis on the basis of the current value pair. Alternatively or additionally, the method comprises a step according to which a comparison of a current torque value of a, in particular the, joint torque of the arm unit is made with a predetermined corresponding value range in order to evaluate the load currently acting on the discharge arm. A load-bearing capacity of the joint device can be dependent on the currently present joint angle. A loading of the joint device can be represented by the torque value of the joint torque. The calculation of the joint torque can take place on the basis of and/or as a function of the current value pair.

In a further embodiment of the invention, the method comprises a step according to which a comparison is made of the current pressure value of the hydraulic pressure or the current force value with a corresponding value range predetermined for each angle value of the joint angle. Alternatively, a comparison is made of the current angle value of the joint angle with a corresponding value range predetermined for each pressure value of the hydraulic pressure or for each force value. A look-up table can be used for the comparison.

In a further embodiment of the invention, the method comprises a step according to which a measure is implemented if at least one of the following conditions is fulfilled. Accordingly, the measure can be implemented if the current pressure value of the hydraulic pressure or the current force value is outside a predetermined corresponding value range. Alternatively or additionally, the measure can be implemented if the current angle value of the joint angle is outside a predetermined corresponding value range. Alternatively or additionally, the measure can be implemented if a, in particular the, current torque value of a, in particular the, joint torque of the arm unit is outside a predetermined corresponding value range. Such a predetermined corresponding value range can be a target value range. Such a predetermined corresponding value range can be defined in the factory and/or structurally limited and/or defined on the basis of a load limit, in particular of the joint device. The load limit can be different for different angle values of the joint angle.

In a further embodiment of the invention, the measure comprises a deceleration and/or stoppage of the, in particular entire, discharge arm relative to the machine base. In this manner an overloading of the discharge arm can be avoided, wherein an overloading is assumed if the predetermined corresponding value range is or has been exceeded.

In a further embodiment of the invention, the steps of the method are carried out while the arm member of the arm unit is adjusted relative to the machine base. The monitoring of the load can take place during the operation of the construction machine.

In a further embodiment of the invention, the discharge arm is configured with multiple joints and has at least two, in particular a plurality of, arm units arranged in series. The discharge arm with at least two arm units arranged in series or adjoining one another can be configured and/or controlled in the manner of a serial robot arm and/or manipulator. The joint device of a first of the arm units connects the arm member of the first arm unit in an articulated manner to the machine base, in particular directly. The joint device of a second of the arm units connects the arm member of this second arm unit in an articulated manner to the first arm unit, in particular directly or indirectly. Further arm units can be present, the arm members thereof being connected in an articulated manner by means of the associated joint devices in each case directly or indirectly to a previous arm unit. The steps of the method are carried out individually at the same time for each arm unit. In this manner a load prevailing on each joint can be individually monitored, in particular in order to avoid an overloading of each joint device.

In a further embodiment of the invention, the arm members are individually pivotably adjusted relative to the machine base and/or relative to one another, in particular in order to adjust relative to the machine base a discharge end of the discharge arm remote from the machine base and/or in order to adapt a pose of the discharge arm. A discharge opening can be present on the discharge end, construction material and/or thick material being able to be discharged through said discharge opening.

In a further embodiment of the invention, the joint axis of the at least one arm unit runs perpendicularly to a direction of gravity.

Expediently, the joint axes of a plurality, in particular all, of the joint devices of the discharge arm run axially parallel to one another and/or horizontally so that the associated arm members are adjustable relative to one another, in particular exclusively, within a vertical boom plane of the construction machine. The discharge arm can be longitudinally extended, in particular fully, along the boom plane. The boom plane can be rotatably adjustable relative to the machine base by means of a slewing gear of the construction machine about a vertical height axis of the construction machine running parallel to the direction of gravity. In particular, the slewing gear is not a joint device according to the present application.

A construction machine according to the invention serves for conveying construction material and/or thick material. The construction machine is designed for, in particular automatically, carrying out a method according to the invention as described above. The advantages of the method according to the invention can thus be utilized by means of the construction machine according to the invention. The construction machine has for each arm unit an angle detection device for step a) of the method. The angle detection device can be designed accordingly for detecting a current angle value of a joint angle of the respective joint device relative to the joint axis. The construction machine also has for each arm unit a pressure detection device and/or a force detection device for step b) of the method. The pressure detection device and/or the force detection device can accordingly be designed for detecting a current pressure value of a hydraulic pressure of the respective arm unit to which its hydraulic device is subjected and/or for detecting a current force value as a function of the pressure value. In addition, the construction machine has an electronic control device at least for step c) of the method. The electronic control device can accordingly be designed for forming the current value pair for each arm unit, in which value pair the respective current angle value and the respective current pressure value or force value are related to one another. The detection devices can have or be in each case a sensor device. The control device can have or be a monitoring device and/or a computing unit. The control device can have a computer for implementing the method. The control device can be connected to the detection devices so as to transmit data, in particular in order to obtain the current angle value and the current pressure value and/or force value for each arm unit for further processing.

In one embodiment of the invention, a conveying line of the construction machine for conveying construction material and/or thick material runs at least in some portions along the discharge arm. The conveying line connects a discharge end of the discharge arm so as to conduct construction material and/or thick material to a construction material and/or thick material pump unit of the construction machine.

Further advantages and features of the invention are found in the claims and in the following description of preferred exemplary embodiments of the invention which are shown by way of the drawings. The same reference signs refer to components which are the same or similar or functionally the same.

It goes without saying that the features mentioned above and those to be explained below in more detail are not only able to be used in the respectively specified combination but also in other combinations or individually without departing from the scope of the present invention.

### BRIEF DESCRIPTION OF THE DRAWINGS

FIG. 1 shows a rough schematic elevation of an embodiment of a construction machine according to the invention which is designed for carrying out a method set forth according to the invention;

FIG. 2 shows schematically a joint torque-joint angle diagram for an arm unit of a discharge arm of the construction machine according to FIG. 1;

FIG. 3 shows a schematic elevation of a further embodiment of the construction machine according to the invention; and

FIG. 4 shows a detail of a discharge arm of a further embodiment of the construction machine according to the invention in an elevation.

### DETAILED DESCRIPTION OF THE DRAWINGS

A construction machine 10 serves for conveying construction material and/or thick material. The construction machine 10 is designed for carrying out a method, which serves for monitoring a load acting on a discharge arm 1 of the construction machine 10.

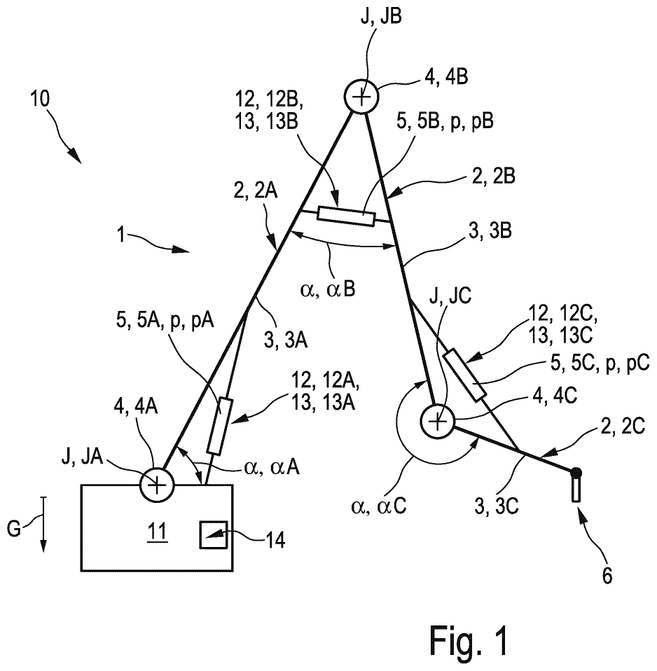

The discharge arm 1 has at least one arm unit 2. According to FIG. 1, the discharge arm 1 has three arm units 2, 2A, 2B, 2C. The construction machine 10 has an angle detection device 12, 12A, 12B, 12C for each arm unit 2, 2A, 2B, 2C. The construction machine 10 also has a pressure detection device 13, 13A, 13B, 13C for each arm unit 2, 2A, 2B, 2C.

Each arm unit 2, 2A, 2B, 2C contains an arm member 3, 3A, 3B, 3C and a joint device 4, 4A, 4B, 4C. The arm members 3, 3A, 3B, 3C are pivotably movably mounted by means of the respective joint device 4, 4A, 4B, 4C relative to a machine base 11 of the construction machine 10 and/or relative to a further arm member 3 of the construction machine 10 about a joint axis J, JA, JB, JC of the respective arm unit 2, 2A, 2B, 2C.

The arm units 2, 2A, 2B, 2C also have in each case a hydraulic device 5, 5A, 5B, 5C for pivotably adjusting the respective arm member 3, 3A, 3B, 3C relative to the machine base 11 and/or relative to the further arm member 3 about the associated joint axis J, JA, JB, JC.

The construction machine 10 in the present case has a conveying line 15. The conveying line 15 serves for conveying construction material and/or thick material. The conveying line 15 runs at least in some portions along the discharge arm 1. The discharge arm 1 has a discharge end 6. A discharge opening of the construction machine 10, which is present at the discharge end 6, is connected by means of the conveying line 15 to a construction material and/or thick material pump unit 16 of the construction machine 10 so as to conduct construction material and/or thick material. The discharge end 6 can be spatially adjusted by adjusting the arm units 2 of the discharge arm 1 relative to the machine base 11 in an environment surrounding the construction machine 10 in order to adjust the discharge opening. The construction machine 10 can be a truck-mounted concrete pump or a trailer-mounted concrete pump.

The construction material and/or thick material pump unit 16 can have conveying cylinders with conveying chambers of variable volume. For the, in particular opposing, alteration of the volumes of the conveying chambers, the conveying cylinders can have in each case an adjustable conveying piston. The construction material and/or thick material pump unit 16 can also contain an S-shaped S-pipe which is connected at one end to a pressure port functioning as a pump outlet, so as to conduct construction material and/or thick material. The S-pipe can be arranged in a storage space which can be filled from above with construction material, for storing construction material and/or thick material. The S-pipe can be rotatably mounted inside the storage space at one end on the pressure port. The conveying chambers of variable volume can lead into the storage space. The S-pipe can be pivotable in the storage space relative to the conveying chambers such that it can be connected alternately to one of the conveying chambers so as to conduct construction material and/or thick material. In this manner, due to the counteraction of the pivoting of the S-pipe and a change in volume of the conveying chambers, construction material and/or thick material located in the storage space can be alternately suctioned by means of the conveying chambers and pumped outwardly via the conveying chambers through the S-pipe via the pressure port. An agitator can be arranged in the storage space of the construction material and/or thick material pump unit 16. A flow of construction material and/or thick material which can be generated by means of the thick material pump unit 16 can be subjected to a pulsation. The pulsation can cause an, in particular dynamic, load to act on the discharge arm 1.

As already indicated, the discharge arm 1 in the present case is configured with multiple joints and has a plurality of arm units 2, 2A, 2B, 2C arranged in series. The joint device 4A of a first of the arm units 2A connects the arm member 3A of the first arm unit 2A in an articulated manner to the machine base 11, for example directly. The joint device 4B of a second of the arm units 2B connects the arm member 3B of this second arm unit 2B in an articulated manner, for example directly, to the first arm unit 2A. The discharge arm 1 in the present case also has a third arm unit 2C. The joint device 4C of the third arm unit 2C connects the arm member 3C of this third arm unit 2C in an articulated manner to the second arm unit 2A, in the present case directly. The joint device 4C of the third arm unit 2C connects the arm member 3C of the third arm unit 2C, in the present case by means of the second arm unit 2B in an articulated manner to the machine base 11, i.e. indirectly.

The method for monitoring the load which acts on the discharge arm 1 comprises steps which, for example, are individually carried out for each arm unit 2, 2A, 2B, 2C. The construction machine 10 has an electronic control device 14.

The method comprises a step a). According to the step a), a current angle value of a joint angle a of the joint device 4 relative to the joint axis J is detected.

The method also comprises a step b). According to step b), a current pressure value of a hydraulic pressure p of the arm unit 2 is detected. The hydraulic device 5 of the respective arm unit 2 is subjected to the hydraulic pressure p. Alternatively or additionally, according to step b), a current force value is detected as a function of the pressure value.

The method also comprises a further step c). According to step c), a current value pair of the respective arm unit 2 is formed. In the value pair, the current angle value resulting from step a) and the current pressure value or force value resulting from step b) are related to one another in pairs in order to monitor the load acting on the discharge arm 1 using the current value pair 2. The control device 14 is designed at least for carrying out step c).

For example, when carrying out step c), a joint torque M is calculated of the respective arm unit 2 which acts relative to the respective joint axis J on the respective arm member 3. The joint torque M is calculated using the current value pair.

The method comprises, for example, a further step, according to which a current torque value of the joint torque M of the respective arm unit 2 is compared with a predetermined corresponding value range W. The comparison of the current torque value with the predetermined corresponding value range W is undertaken, for example, in order to evaluate the load currently acting on the discharge arm 1. The calculation of the joint torque M can be made on the basis of and/or as a function of the current value pair.

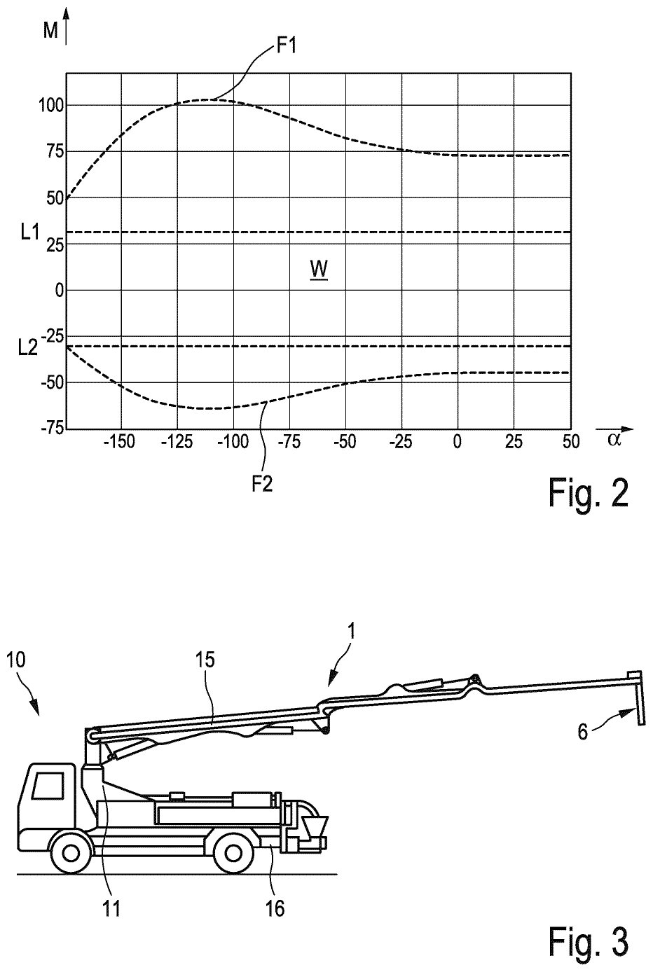

As can be identified in FIG. 2, a load-bearing capacity of the respective joint device 4 can vary over the joint angle a. Accordingly, an upper load limit F1 and a lower load limit F2 change as a function of the respective joint angle a. An upper range limit L1 and a lower range limit L2 of the corresponding value range W predetermined for the joint torque M can be constant, i.e. independent of the joint angle a. In this manner, it can be ensured that the current torque value is at least generally in a load range with a sufficient safety margin from the load limits F1, F2 as long as the load range corresponds to the value range W.

For example, the method comprises a further step. According to this further step, either the current pressure value of the hydraulic pressure p is compared with a corresponding value range predetermined for each angle value of the joint angle a or the current angle value of the joint angle a is compared with a corresponding value range predetermined according to each pressure value of the hydraulic pressure p. Alternatively, according to this step either the current force value can be compared with a corresponding value range predetermined for each angle value of the joint angle a or the current angle value of the joint angle a can be compared with a corresponding value range predetermined for each force value.

For example, in a further step of the method, a measure is implemented if the current pressure value of the hydraulic pressure p or the current force value is outside a predetermined corresponding value range. Alternatively or additionally, the measure is implemented if the current angle value of the joint angle a is outside a predetermined corresponding value range. Alternatively or additionally, the measure is implemented if the current torque value of the joint torque M of the arm unit 2 is outside a predetermined corresponding value range W. The predetermined corresponding value range can be defined in the factory. Alternatively or additionally, the predetermined corresponding value range can be structurally limited. Alternatively or additionally, the predetermined corresponding value range can be defined on the basis of a load limit, in particular of the joint device 4.

The load limit can be different for different angle values of the joint angle a, see FIG. 2. It can be identified that the joint device 4, viewed in FIG. 2, has a maximum load-bearing capacity for positive and negative joint torques M at an angle value of the joint angle a of approximately −100° to −125°. Accordingly, the load-bearing capacity according to FIG. 2 is minimal at an angle value of approximately −25°. At an angle value of approximately 0°to +50° the load-bearing capacity can be between the maximum and the minimum load-bearing capacity. According to FIG. 2, the joint angle a can have an angle value of approximately−175° to +50°.

The measure, which can be implemented as a function of the conditions set forth above, can comprise a deceleration and/or a stoppage of the discharge arm 1 relative to the machine base 2. In particular, the discharge arm 1 can be fully decelerated and/or stopped, i.e. all of the arm units 2 can be decelerated and/or stopped, in particular relative to the machine base 11. The measure can be controlled by means of the control device 14.

The steps of the method are carried out, for example, while the arm member 3 of the respective arm unit 2 is adjusted relative to the machine base 11. The steps of the method can thus be carried out while the discharge end 6 of the discharge arm 1 is moved in the surroundings of the construction machine 10. In particular, the steps of the method can be carried out while construction material and/or thick material is conveyed by means of the construction machine 10 and distributed by means of the discharge arm 1.

The discharge arm 1 is configured in the present case in the manner of a serial robot arm. The discharge arm 1 can be configured as manipulator. The discharge arm 1 can be controllable in the manner of a serial robot arm or manipulator. Due to the controlling, the arm members 3, 3A, 3B, 3C can be individually pivotably adjusted relative to the machine base 11 and/or relative to one another. Due to the individual pivotable adjustment of the arm members 3, 3A, 3B, 3C, the discharge end 6 of the discharge arm 1 remote from the machine base 11 can be adjusted relative to the machine base 11. Alternatively or additionally, a pose of the discharge arm 1 can be adapted by the individual pivotable adjustment of the arm members 3, 3A, 3B, 3C.

In the method according to the invention, a pressure measurement can be taken in hydraulic cylinders of the hydraulic devices 5 in order to measure a cylinder force of the relevant hydraulic cylinders. In addition, it is possible to determine the joint angle a as the relative angle between, in particular adjacent, arm members 3 by the angle detection devices, in particular arm angle sensors. For each joint device 4, permitted cylinder forces, in particular for tension and compression, as a function of the joint angle, can be stored in the controller of the discharge arm 1, for example in the control device 14. If said values are exceeded, an active adjustment of the discharge arm 1 can be prevented by the controller. In this manner, it can be achieved that exceeding a design joint torque of the discharge arm 1 or the joint device 4 is avoided as a result of an active adjustment of the discharge arm 1.

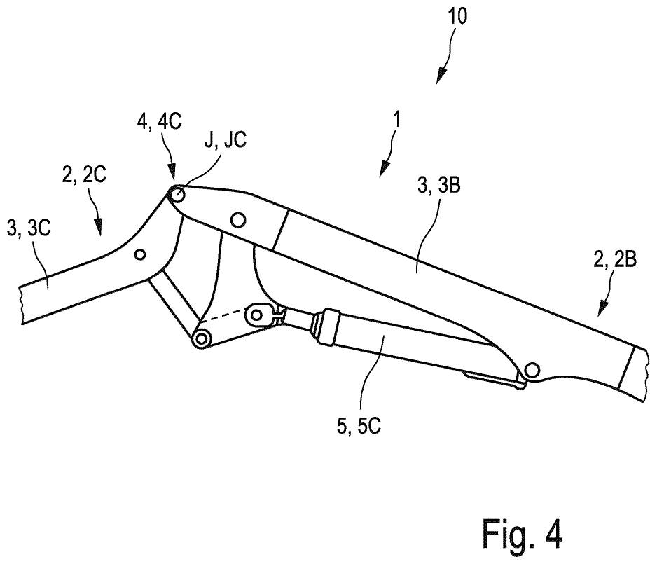

FIG. 4 shows by way of example the arm unit 2, 2C, in particular its joint device 4, 4C and its hydraulic device 5, 5C. It can be identified that a transmission kinematics can be present for coupling the hydraulic device 5, 5C firstly to the arm member 3, 3C and secondly to the further arm member 3, 3B of the arm unit 2, 2B in the region of the joint device 4, 4C. The transmission kinematics can contain a coupling gear which is designed to translate the cylinder force generated by means of the hydraulic device 5, 5C. It goes without saying that the other arm units 2 can have a similar or identical transmission kinematics for coupling their hydraulic devices 5.

For example, the joint axis J of the at least one arm unit 2 runs perpendicularly to a direction of gravity G. In particular, the joint axis J of the at least one arm unit 2 runs horizontally.

For example, the joint axes J, JA, B, JC of a plurality, in the present case all, of the joint devices 4, 4A, 4B, 4C of the discharge arm 1 run axially parallel to one another and/or horizontally so that the associated arm members 3, 3A, 3B, 3C are adjustable relative to one another, in the present case exclusively, within a vertical boom plane of the construction machine 10. The boom plane, in particular incorporating the discharge arm 1, can be adjustable about a vertical height axis of the construction machine 10 running parallel to the direction of gravity G by means of a slewing mechanism of the construction machine 10 relative to the machine base 11. In particular, the slewing mechanism is not a joint device according to the present application.

1.-11. (canceled)

12. A method for monitoring a load that acts on a discharge arm of a construction machine for conveying construction material and/or thick material, the method comprising the steps of:
a) detecting a current angle value of a joint angle of a joint device relative to a joint axis, wherein the joint device pivotably movably mounts an arm member of an arm unit of the discharge arm relative to a machine base of the construction machine, or relative to a further arm member of a further arm unit, about the joint axis;
b) detecting a current pressure value of a hydraulic pressure of the arm unit to which a hydraulic device, for pivotably adjusting the arm member relative to the machine base or the further arm member about the joint axis, is subjected, and/or detecting a current force value as a function of the pressure value;
c) forming a current value pair of the arm unit, in which value pair the current angle value resulting from step (a) and the current pressure value or force value resulting from step (b) are related to one another, in order to monitor the load acting on the discharge arm on the basis of the current value pair.

13. The method according to claim 12, wherein at least one of:
(i) the step c) comprises calculating a joint torque of the arm unit acting on the arm member relative to the joint axis on the basis of the current value pair; or
(ii) the method further comprises the step of comparing a current torque value of a joint torque of the arm unit with a predetermined corresponding value range in order to evaluate the load currently acting on the discharge arm.

14. The method according to claim 12, further comprising the step of:
comparing the current pressure value of the hydraulic pressure or the current force value with a corresponding value range predetermined for each angle value of the joint angle, or comparing the current angle value of the joint angle with a corresponding value range predetermined for each pressure value of the hydraulic pressure or for each force value.

15. The method according to claim 12, further comprising the step of:
implementing a measure when at least one of the following conditions is fulfilled:
(i) the current pressure value of the hydraulic pressure or the current force value is outside a predetermined corresponding value range;
(ii) the current angle value of the joint angle is outside a predetermined corresponding value range; or
(iii) a current torque value of a joint torque of the arm unit is outside a predetermined corresponding value range.

16. The method according to claim 15, wherein
the measure comprises a deceleration and/or stoppage of the discharge arm relative to the machine base.

17. The method according to claim 12, wherein the steps of the method are carried out while the arm member of the arm unit is adjusted relative to the machine base.

18. The method according to claim 12, wherein
the discharge arm is configured with multiple joints and has at least two arm units arranged in series,
the joint device of a first of the arm units connects the arm member of the first arm unit in an articulated manner to the machine base,
the joint device of a second of the arm units connects the arm member of the second arm unit, in an articulated manner to the first arm unit,
the steps of the method are carried out individually at the same time for each arm unit.

19. The method according to claim 18, wherein
the arm members are individually pivotably adjusted relative to the machine base and/or relative to one another, in order to adjust relative to the machine base a discharge end of the discharge arm remote from the machine base and/or in order to adapt a pose of the discharge arm.

20. The method according to claim 12, wherein the joint axis of the arm unit runs perpendicularly to a direction of gravity.

21. The method according to claim 18, wherein
the joint axes of a plurality of the joint devices of the discharge arm run axially parallel to one another and/or horizontally so that the associated arm members are adjustable relative to one another within a vertical boom plane of the construction machine.

22. A construction machine for conveying construction material and/or thick material, comprising:
a discharge arm upon which a load acts, the discharge arm having a plurality of arm units,
wherein each arm unit has an arm member, a joint device which pivotably movably mounts the arm member relative to a machine base of the construction machine or relative to a further arm member about a joint axis of the arm unit, and a hydraulic device for pivotably adjusting the arm member relative to the machine base or the further arm member about the joint axis,
wherein each arm unit further has an angle detection device and a pressure detection device; and
an electronic control device operatively configured to:
a) detect, via the angle detection device, a current angle value of a joint angle of the joint device relative to the joint axis;
b) detect, via the pressure detection device, a current pressure value of a hydraulic pressure of the arm unit to which its hydraulic device is subjected and/or a current force value as a function of the pressure value; and
c) form a current value pair of the arm unit, in which value pair the current angle value resulting from (a) and the current pressure value or force value resulting from step (b) are related to one another in order to monitor the load acting on the discharge arm on the basis of the current value pair.

23. The construction machine according to claim 22, further comprising:
a conveying line of the construction machine for conveying the construction material and/or thick material, the connecting line running at least in some portions along the discharge arm,
wherein the conveying line connects a discharge end of the discharge arm so as to conduct construction material and/or thick material to a construction material and/or thick material pump unit of the construction machine.
